(19) United States
(12) Patent Application Publication
(10) Pub. No.: US 2015/0035462 A1
(43) Pub. Date: Feb. 5, 2015

(54) MOTOR CONTROLLER

(71) Applicant: DENSO CORPORATION, Kariya-city (JP)

(72) Inventor: Ryuhei KISHIMOTO, Suzuka-city (JP)

(21) Appl. No.: 14/336,135

(22) Filed: Jul. 21, 2014

(30) Foreign Application Priority Data
Aug. 1, 2013 (JP) 2013-160702

(51) Int. Cl. H02P 6/14

(52) U.S. Cl. CPC H02P 6/14
USPC 318/400.13

(57) ABSTRACT

A motor controller includes an inverter portion having an upper switching element and a lower switching element which are connected in series, and an inverter control portion generating control signals and controlling a drive of each switching element. The inverter control portion generates the control signals such that (i) different phases of the upper switching element and the lower switching element are synchronously energized and intermittently turned on, (ii) a pulse-width modulation period of the upper switching element is equal to a pulse-width modulation period of the lower switching element, (iii) an on-period of one of the upper switching element and the lower switching element is greater than an off-period of the other one of the upper switching element and the lower switching element, and (iv) the off-period is in a time period from a time point the on-period starts to a time point the on-period completes.

### CROSS REFERENCE TO RELATED APPLICATION

This application is based on Japanese Patent Application No. 2013-160702 filed on Aug. 1, 2013, the disclosure of which is incorporated herein by reference.

### TECHNICAL FIELD

The present disclosure relates to a motor controller which controls a drive of a polyphase motor.

### BACKGROUND

Conventionally, as disclosed in JP-2007-252034A (US 2007/0216345 A1), a driving device of a brushless motor provided with three phases and driven by a signal having a square waveform is known. The driving device corresponding to a motor controller is energized by the signal having a square waveform at an electrical angle of 120 degrees.

In JP-2007-252034A, a PWM control that one of an upper switching element and a lower switching element which have different phases that are synchronously controlled (synchronously energized) is continuously turned on and the other one of the upper switching element and the lower switching element is intermittently turned on is executed.

The switching elements are switched for twice in a period of the PWM, respectively. In this case, a switching loss is generated, and the switching elements generate heat. A switching number of the switching element which is intermittently turned on is greater than a switching number of the switching element which is continuously turned on. Therefore, a heat-generation quantity of the switching element which is intermittently turned on becomes relatively high.

### SUMMARY

It is an object of the present disclosure to provide a motor controller which can reduce a heat-generation quantity of a switching element intermittently turned on.

According to an aspect of the present disclosure, a motor controller controlling a drive of a polyphase motor includes an inverter portion and an inverter control portion. The inverter portion includes an upper switching element and a lower switching element which are connected between a power source and the ground in series and corresponds to each phase of the polyphase motor. The upper switching element corresponds to a positive electrode of the upper switching element and the lower switching element. The inverter control portion generates control signals having pulse-width modulation waveforms, and controls a drive of the upper switching element and the lower switching element. The inverter control portion generates the control signals such that (i) different phases of the upper switching element and the lower switching element are synchronously energized and intermittently turned on, (ii) a pulse-width modulation period of the upper switching element is equal to a pulse-width modulation period of the lower switching element, (iii) an on-period of one of the upper switching element and the lower switching element is greater than an off-period of the other one of the upper switching element and the lower switching element, and (iv) the off-period is in a time period from a time point the on-period starts to a time point the on-period completes.

The control signals of the switching elements such that the on-period is greater than the off-period, and the off-period is in a time period from a time point the on-period starts to a time point the on-period completes. Therefore, a pulse-width modulation period of an output of the inverter portion is less than the pulse-width modulation periods of the upper switching element and the lower switching element. Since the pulse-width modulation periods of the upper switching element and the lower switching element are greater than the pulse-width modulation period of the output of the inverter portion, a switching number of the switching element which is intermittently turned on can be reduced with respect to that of a conventional technology. Therefore, a heat-generation quantity of the switching element which is intermittently turned on can be reduced with respect to that of the conventional technology.

Further, a lifetime of the switching element which is intermittently turned on can be extended with respect to that of the conventional technology. Alternatively, when the same lifetime as the conventional technology is necessary, the switching element which is intermittently turned on can use a low-price switching element.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an outline of a motor controller according to an embodiment of the present disclosure;

FIG. 2 is a diagram showing an outline of a microcomputer in FIG. 1;

FIG. 3 is a diagram showing an energization pattern of control signals and an output pattern of an inverter portion;

FIG. 4 is a diagram showing a relationship between the energization of the control signals and the output of the inverter portion, according to a comparison example;

FIG. 5 is a diagram showing a relationship between the energization of the control signals and the output of the inverter portion, according to the embodiment;

FIG. 6 is a diagram showing a relationship between the energization of the control signals and the output of the inverter portion, when an output duty-ratio is increased with respect to that in FIG. 5; and

FIG. 7 is a diagram showing a relationship between the energization of the control signals and the output of the inverter portion, when an output duty-ratio is decreased with respect to that in FIG. 5.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, referring to drawings, an embodiment of the present disclosure will be described. The substantially same parts or components as those in the embodiments are indicated with the same reference numerals.

### Embodiment

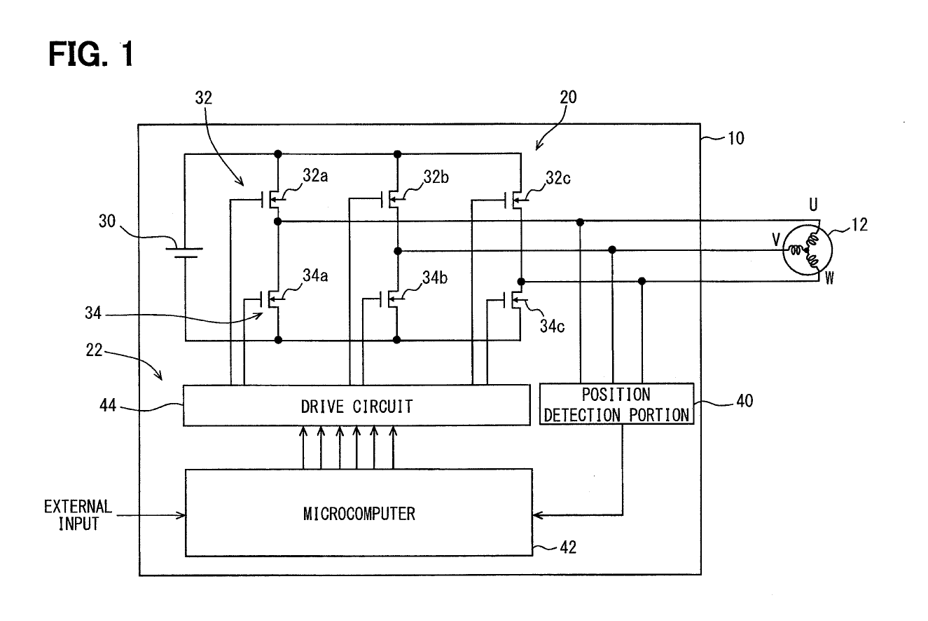

As shown in FIG. 1, a motor controller 10 controls a drive of a polyphase motor 12. According to the present embodiment, a brushless motor provided with three phases is used as the polyphase motor 12. Specifically, a direct current brushless motor (DC brushless motor) provided with three phases is used as the polyphase motor 12. Further, the brushless motor is driven by a signal having a square waveform. The brushless motor can be used to drive a fuel pump mounted to a vehicle or a fan provided in a radiator.

Next, referring to FIG. 1, a configuration of the motor controller 10 will be described.

As shown in FIG. 1, the motor controller 10 includes an inverter portion 20 and an inverter control portion 22.

The inverter portion 20 is connected with three phases of the polyphase motor 12 to apply a voltage from a battery 30 to the three phases. Three phases of the polyphase motor 12 are U-phase, V-phase, and W-phase. The inverter portion 20 includes switching elements 32 and 34 which are referred to as an upper switching element 32 and a lower switching element 34. Further, the upper switching element 32 includes an upper U-phase switching element 32a, an upper V-phase switching element 32b, and an upper W-phase switching element 32c corresponding to the U-phase, the V-phase, and the W-phase, respectively, and the lower switching element 34 includes a lower U-phase switching element 34a, a lower V-phase switching element 34b, and a lower W-phase switching element 34c corresponding to the U-phase, the V-phase, and the W-phase, respectively. According to the present embodiment, the upper switching element 32 and the lower switching element 34 correspond to n-type metal-oxide-semiconductor field-effect transistors (n-type MOSFETs).

The upper U-phase switching element 32a and the lower U-phase switching element 34a are connected between a cathode terminal of the battery 30 and an anode terminal of the battery 30 in series, and the upper U-phase switching element 32a corresponds to a positive electrode of the upper U-phase switching element 32a and the lower U-phase switching element 34a. According to the present embodiment, the cathode terminal of the battery 30 corresponds to a power source, and the anode terminal of the battery 30 corresponds to the ground. Further, a connection point of the upper U-phase switching element 32a and the lower U-phase switching element 34a is connected with the U-phase of the polyphase motor 12. The upper V-phase switching element 32b and the lower V-phase switching element 34b are connected between the cathode terminal of the battery 30 and the anode terminal of the battery 30 in series, and the upper V-phase switching element 32b corresponds to a positive electrode of the upper V-phase switching element 32b and the lower V-phase switching element 34b. Further, a connection point of the upper V-phase switching element 32b and the lower V-phase switching element 34b is connected with the V-phase of the polyphase motor 12.

The upper W-phase switching element 32c and the lower W-phase switching element 34c are connected between the cathode terminal of the battery 30 and the anode terminal of the battery 30 in series, and the upper W-phase switching element 32c corresponds to a positive electrode of the upper W-phase switching element 32c and the lower W-phase switching element 34c. Further, a connection point of the upper W-phase switching element 32c and the lower W-phase switching element 34c is connected with the W-phase of the polyphase motor 12. in the inverter portion 20, six switching elements 32a, 32b, 32c, 34a, 34b, and 34c are connected in a three-phase bridge.

The inverter control portion 22 generates control signals having pulse-width modulation waveforms (PWM waveforms), and controls a drive of the upper switching element 32 and the lower switching element 34 according to the control signals. The inverter control portion 22 includes a position detection portion 40, a microcomputer 42, and a drive circuit 44.

The position detection portion 40 detects and outputs a position information relative to a rotation angle of the polyphase motor 12. According to the present embodiment, the position detection portion 40 detects a rotational position of a rotor of the polyphase motor 12 by a known method based on an induced voltage of each phase of the polyphase motor 12. Specifically, the position detection portion 40 detects the rotational position at each electrical angle of 60 degrees. In addition, the position detection portion 40 may use a detection method to detect the rotational position by using a sensor such as a hall-effect element. For example, three hall-effect elements are placed at positions having 120 degrees with respect to each other, and a center of the hall-effect elements corresponds to a rotational center of the rotor.

The microcomputer 42 includes a CPU, a ROM, a RAM, a register, an inner timer, and an input-output circuit. In the microcomputer 42, the CPU executes various calculations using the RAM and the register as a temporary storage area, based on an input signal transmitted from outside or a program stored in the ROM.

The drive circuit 44 is a pre driver driving the switching elements 32 and 34 of a power system which drives the polyphase motor 12. The drive circuit 44 includes six MOSFETs (not shown) corresponding to the switching elements 32 and 34.

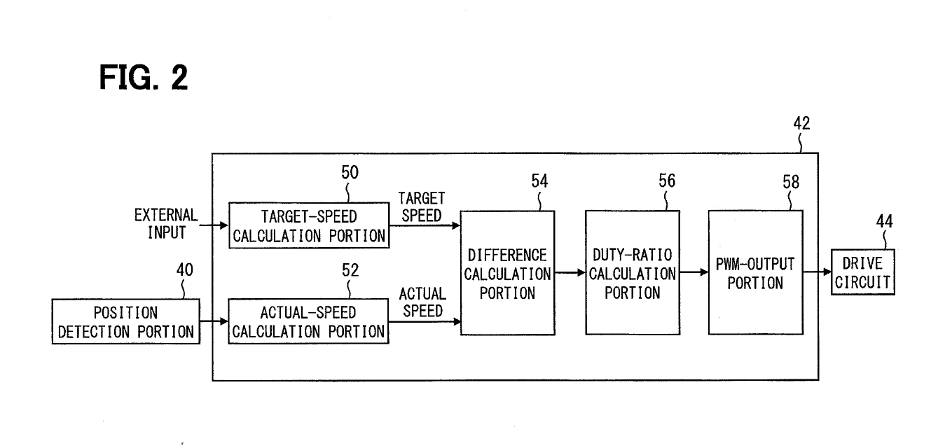

Next, referring to FIG. 2, a configuration of the microcomputer 42 will be described.

As shown in FIG. 2, the microcomputer 42 further includes a target-speed calculation portion 50, an actual-speed calculation portion 52, a difference calculation portion 54, a duty-ratio calculation portion 56, and a PWM-output portion 58.

The target-speed calculation portion 50 calculates a target speed corresponding to a target rotational number per unit time, based on an external input such as a signal of a switch operated by an external ECU, a sensor, or a user. The target rotational number corresponds to a target rotational value of the polyphase motor 12.

The actual-speed calculation portion 52 calculates an actual speed corresponding to an actual rotational number per unit time, based on the rotational position of the rotor detected by the position detection portion 40. The actual rotational number corresponds to an actual rotational value of the polyphase motor 12.

The difference calculation portion 54 calculates a difference between the target speed and the actual speed. The difference calculation portion 54 outputs the difference to the duty-ratio calculation portion 56.

The duty-ratio calculation portion 56 calculates a duty-ratio for feedback controlling the polyphase motor 12 based on the difference, so that the actual speed follows the target speed. According to the present embodiment, the duty-ratio calculation portion 56 executes a proportional-integral (PI) control.

The duty-ratio calculation portion 56 calculates an output duty-ratio corresponding to a duty-ratio of the output of the inverter portion 20, based on the difference, and ratio constants Kp, Ki. Then, the duty-ratio calculation portion 56 sets duty-ratios of the control signals controlling the switching elements 32, 34, based on the output duty-ratio of the inverter portion 20. For example, a relationship between the output duty-ratio and the duty-ratios of the control signals is predetermined and stored in the ROM. When the output duty-ratio is necessary to be 50%, the duty-ratios of the control signals are set to 75%. The duty-ratio calculation portion 56 calculates the duty-ratios of the control signals and outputs the duty-ratios to the PWM-output portion 58.

The PWM-output portion 58 generates the control signals at a predetermined time period or a predetermined frequency based on the duty-ratio inputted from the duty-ratio calculation portion 56, so as to control a drive of the switching elements 32, 34. Then, the PWM-output portion 58 outputs the control signals to the drive circuit 44.

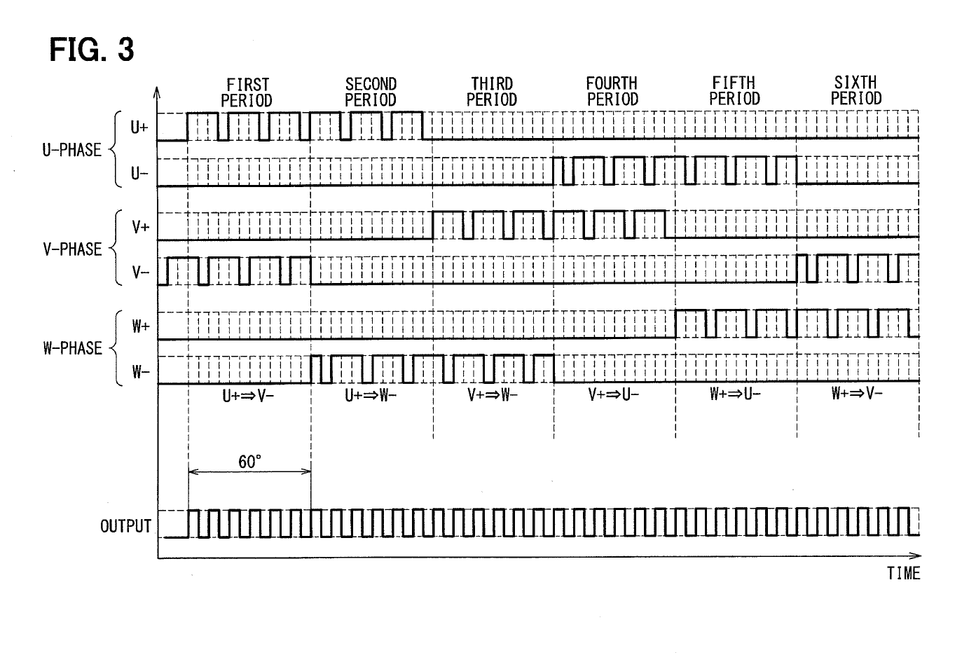

As shown in FIG. 3, when the upper switching element 32 and the lower switching element 34 are controlled to be synchronously energized, the PWM-output portion 58 generates the control signals in a manner that one of the upper switching elements 32 has the same PWM period as one of the lower switching elements 34 except a corresponding lower switching element which corresponds to the one of the upper switching elements 32. The one of the upper switching elements 32 is referred to as an upper selected element, and the one of the lower switching elements 34 except the corresponding lower switching element which corresponds to the one of the upper switching elements 32 is referred to as a lower selected element. Further, the PWM-output portion 58 generates the control signals in a manner that an on-period of one of the upper selected element and the lower selected element is greater than an off-period of the other one of the upper selected element and the lower selected element, and the off-period is in a time period from a time point that the on-period starts to a time point that the on-period completes. According to the present embodiment, the PWM-output portion 58 also generates the control signals in a manner that the duty-ratio is equal to a value greater than 50%, and a center point of the on-period is equal to a center point of the off-period. The control signals can be generated by the upper selected element and the lower selected element which have the same PWM period and the same duty-ratio and a phase of the upper selected element is shifted from the lower selected element for a half of the PWM period.

FIG. 3 is a diagram showing an energization pattern of the control signals of the switching elements 32, 34, and an output pattern of the inverter portion 20. As shown in FIG. 3, the energization pattern is divided into six periods at each electrical angle of 60 degrees. As shown in FIG. 3, control signals “U+”, “V+”, and “W+” indicates signals in the upper U-phase switching element 32a, the upper V-phase switching element 32b, and the upper W-phase switching element 32c, respectively, and control signals “U−”, “V−”, and “W−” indicates signals in the lower U-phase switching element 34a, the lower V-phase switching element 34b, and the lower W-phase switching element 34c, respectively. Further, the output of the inverter portion 20 indicates a sum of the phases.

In a first period, the upper U-phase switching element 32a and the lower V-phase switching element 34b are synchronously controlled (synchronously energized), and a current flows from the upper U-phase switching element 32a to the lower V-phase switching element 34b via the polyphase motor 12. In the first period, a first on-period of one of the control signals “U+”, “V−” is greater than a second off-period of the other one of the control signals “U+”, “V−”, and the second is in a time period from a time point that the first on-period starts to a time point that the first on-period completes.

In a second period, the upper U-phase switching element 32a and the lower W-phase switching element 34c are synchronously controlled. In a third period, the upper V-phase switching element 32b and the lower W-phase switching element 34c are synchronously controlled. In a fourth period, the upper V-phase switching element 32b and the lower U-phase switching element 34a are synchronously controlled. In a fifth period, the upper W-phase switching element 32c and the lower U-phase switching element 34a are synchronously controlled. In a sixth period, the upper W-phase switching element 32c and the lower V-phase switching element 34b are synchronously controlled. Further, in the second period to the sixth period, the control signal of the upper switching element 32 and the control signal of the lower switching element 34 are synchronously controlled, the on-period is greater than the off-period, and the off-period in is a time period from a time point that the on-period starts to a time point that the on-period completes.

The target-speed calculation portion 50, the actual-speed calculation portion 52, the difference calculation portion 54, the duty-ratio calculation portion 56, and the PWM-output portion 58 may function by using hardware, software, or a combination of hardware and software.

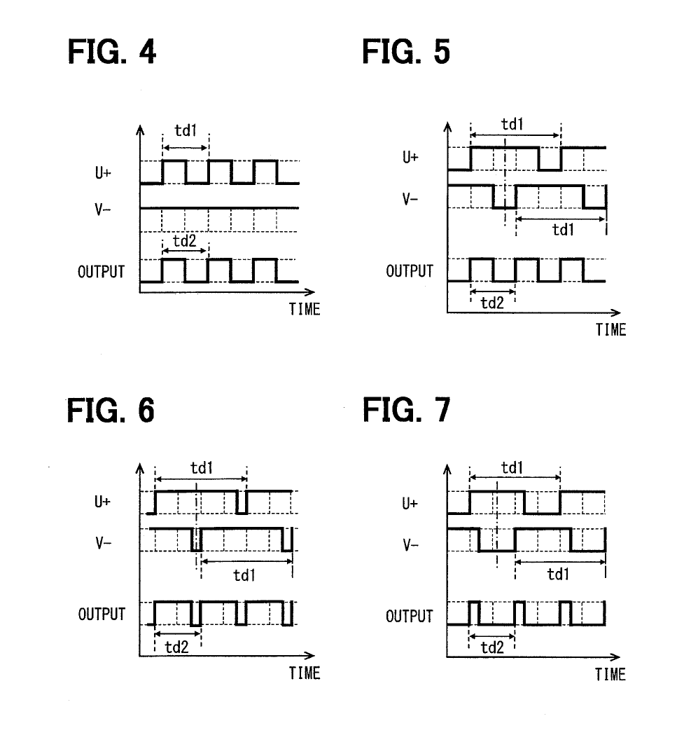

Next, referring to FIGS. 4 to 7, the control signal of the upper switching element 32 and the control signal of the lower switching element 34 which are synchronously controlled will be described. Further. FIGS. 4 to 7 only show the first period as FIG. 3, other periods are similar to those in FIG. 3.

FIG. 4 is a diagram showing a comparison example in which the energization pattern of conventional control signals and the output pattern of the inverter portion 20. Conventionally, as shown in FIG. 4, the switching elements which are synchronously controlled by a PWM control that the lower V-phase switching element is continuously turned on and the upper U-phase switching element is intermittently turned on. Alternatively, in the PWM control, the upper U-phase switching element is continuously turned on and the lower V-phase switching element is intermittently turned on. Then, a duty-ratio of the control signal “U+” is set to 50%, and a duty-ratio of the control signal “V−” is set to 100%, such that the output duty-ratio of the inverter portion is equal to 50%.

In this case, a PWM period td1 of the control signal “U+” is substantially equal to a PWM period td2 of the output of the inverter portion. As shown in FIG. 4, since the PWM periods td1, td2 are necessary to be substantially equal to each other, the control signal “U+” is necessary to have three pulses to obtain three pulses in the output that the duty-ratio of which is equal to 50%. That is, the upper U-phase switching element is necessary to be switched for six times. The lower V-phase switching element is unnecessary to be switched. In other words, a switching number of the lower V-phase switching element is zero.

A switching number of the upper U-phase switching element which is intermittently turned on is greater than that of the lower V-phase switching element which is continuously turned on. Since a heat-generation quantity due to a switching loss increases in accordance with an increase in switching number, the heat-generation quantity of the upper U-phase switching element is greater than that of the lower V-phase switching element.

In this case, a lifetime of the upper U-phase switching element is shortened. Therefore, it is necessary to use a switching element which has high heat resistance and a high price, so as to ensure a specified lifetime of the upper U-phase switching element.

When the switching number is large, a switching noise may generate. Further, the heat-generation quantity varies in the upper U-phase switching element and the lower V-phase switching element. That is, the heat-generation quantity varies in the switching elements forming the inverter portion.

In addition, it is known that the duty-ratio of the control signal “V−” is set to 50% as the same as the control signal “U+”, and the output duty-ratio of the inverter portion is controlled to become 50% by matching timings of turning on or off the control signals “U+”, “V−”. In this case, since the duty-ratio of the control signal “U+” is equal to the duty-ratio of the control signal “V−”, a difference between the heat-generation quantity of the upper U-phase switching element and the heat-generation quantity of the lower V-phase switching element can be restricted. As the same as the control signals shown in FIG. 4, the PWM periods td1 of the control signals “U+”, “V−” are substantially equal to the PWM period td2 of the output of the inverter portion. Therefore, it is necessary to switch the upper U-phase switching element and the V-phase switching element for six times, respectively, so as to obtain the three pluses in the output that the duty-ratio of which is equal to 50%. The switching number becomes large, and a high heat-generation quantity is generated.

In contrast, according to the present embodiment, as shown in FIG. 5, the upper U-phase switching element 32a and the lower V-phase switching element 34b are controlled to be synchronously energized by a PWM control that both the upper U-phase switching element 32a and the lower V-phase switching element 34b are intermittently turned on. Further, the duty-ratio of the control signal “U+” and the duty-ratio of the control signal “V−” are both set to 75%, such that the output duty-ratio of the inverter portion is equal to 50% as the same as the output duty-ratio shown in FIG. 4. The control signals “U+”, “V−” are generated in a manner that a center point of an on-period of one of the control signals “U+”, “V−” is equal to a center point of an off-period of the other of the control signals “U+”, “V−”. In other words, the control signals “U+”, “V−” are generated in a manner that a phase of the control signal “U+” is shifted from a phase of the control signal “V−” for a half of the PWM period. As shown in FIG. 5, the PWM periods of the control signals “U+”, “V−” are referred to as td1, and the PWM period of the output of the inverter portion 20 which is a half of the PWM period td1 is referred to as td2

As shown in FIG. 5, the upper U-phase switching element 32a is switched for three times and the lower V-phase switching element 34b is switched for three times, so as to obtain three pulses in the output that the duty-ratio of which is equal to 50%. The switching number of the switching elements 32a, 34b which are intermittently turned on can be reduced with respect to that of a conventional technology.

FIG. 6 is a diagram showing an example that the output duty-ratio of the inverter portion 20 is greater than that in FIG. 5.

The duty-ratio of the control signal may increase to increase the output duty-ratio. As shown in FIG. 6, the PWM periods of the control signals “U+”, “V−” are referred to as td1, and the duty-ratio of the control signal “U+” and the duty-ratio of the control signal “V−” are set to the same value that is 90%. The control signals “U+”, “V−” are generated in a manner that the center point of the on-period of one of the control signals “U+”, “V−” is equal to the center point of the off-period of the other of the control signals “U+”, “V−”. Therefore, the PWM period td2 of the output of the inverter portion 20 is a half of the PWM period td1. Thus, the output duty-ratio of the inverter portion 20 is a value greater than 50%. According to the above description, the output duty-ratio is about 80%.

When it is necessary to obtain the output duty-ratio that is equal to 80%, the duty-ratio calculation portion 56 sets the duty-ratios of the control signals to 90% based on the difference calculated by the difference calculation portion 54.

FIG. 7 is a diagram showing an example that the output duty-ratio of the inverter portion 20 is less than that in FIG. 5.

The duty-ratio of the control signal may decrease to decrease the output duty-ratio. As shown in FIG. 7, the PWM periods of the control signals “U+”, “V−” are referred to as td1, and the duty-ratio of the control signal “U+” and the duty-ratio of the control signal “V−” are set to the same value that is 60%. The control signals “U+”, “V−” are generated in a manner that the center point of the on-period of one of the control signals “U+”, “V−” is equal to the center point of the off-period of the other of the control signals “U+”, “V−”. Therefore, the PWM period td2 of the output of the inverter portion 20 is a half of the PWM period td1. Thus, the output duty-ratio of the inverter portion 20 is a value less than 50%. According to the above description, the output duty-ratio is about 20%.

When it is necessary to obtain the output duty-ratio that is equal to 20%, the duty-ratio calculation portion 56 sets the duty-ratios of the control signals to 60% based on the difference calculated by the difference calculation portion 54.

Next, effects of the motor controller 10 according to the present embodiment will be described.

According to the present embodiment, the control signals of the switching elements 32, 34 which are synchronously controlled are generated in a manner that (i) the PWM periods are the same value, (ii) the on-period of one of the switching elements 32, 34 is greater than the off-period of the other of the switching elements 32, 34, and (iii) the off-period is in a time period from a time point that the on-period starts to a time point that the on-period completes.

Therefore, the PWM period td2 of the output of the inverter portion 20 is less than the PWM period td1 of the upper switching element 32 and the lower switching element 34. That is, each control signal has the PWM period greater than the output of the inverter portion 20 have. Therefore, the switching number of the switching elements 32, 34 which are intermittently turned on can be reduced with respect to that of the conventional technology. Further, the heat-generation quantities of the switching elements 32, 34 can be reduced with respect to those of the conventional technology.

When MOSFETs are used as the switching elements 32, 34, a total heat-generation quantity Pc of one MOSFET can be calculated by an equation as following.

Pc=(ton/td)×Ron×Im²+(tsw/td)×Im×Vb×⅓

In the equation, “ton” indicates the on-period, “td” indicates a period, “Ron” indicates an on resistance, “Im” indicates a current flowing through the MOSFET, “tsw” indicates a switching transition period corresponding to a time period between a time point the MOSFET is turned on and a time point the MOSFET is turned off, and “Vb” indicates a power voltage. Further, a first term “(ton/td)×Ron×Im²” indicates a Joule heat generated according to the on resistance of the MOSFET, and a second term “(tsw/td)×Im×Vb×⅓” indicates a switching heat generated by switching the MOSFET.

According to the present embodiment, the PWM periods td1 of the switching elements 32, 34 which are intermittently turned on can be twice as the PWM period td2 of the output of the inverter portion 20. That is, the PWM period td1 of the present embodiment can be twice as that of the conventional technology. Therefore, in the equation, since the period td corresponds to the PWM period td2, the total heat-generation quantity Pc including the switching heat can be reduced.

Since the heat-generation quantity can be reduced, lifetimes of the switching elements 32, 34 which are intermittently turned on can be extended with respect to those of the conventional technology. Alternatively, when the same lifetime as the conventional technology is necessary, the switching elements 32, 34 can use low-price switching elements which have a shorter lifetime with respect to the switching elements which have high heat resistance and high price. Since the PWM periods of the switching elements 32, 34 and the duty-ratios of the switching elements 32, 34 are equal to each other, respectively, a variation of the heat-generation quantities in the switching elements 32, 34 can be reduced.

The switching number of the switching elements 32, 34 can be reduced with respect to that of the conventional technology. In other words, when the same output is ensured, the PWM period of the control signal can be extended with respect to that of the conventional technology. Therefore, the switching noise can be prevented from generating.

According to the present embodiment, as shown in FIGS. 5 to 7, the control signals are generated in a manner that the duty-ratios of different phases of the upper switching element 32 and the lower switching element 34 which are synchronously controlled are set to the same value greater than 50%. Therefore, since the duty-ratios of the control signals are the same, when the duty-ratio calculation portion 56 functions according to hardware, a configuration of the duty-ratio calculation portion 56 can be simplified. Further, since the duty-ratios of the control signals are the same, when the duty-ratio calculation portion 56 functions according to software, a load to be processed can be reduced.

According to the present embodiment, as shown in FIGS. 5 to 7, the control signals are generated in a manner that the duty-ratios of the upper switching element 32 and the lower switching element 34 are set to the same value greater than 50%, and the center point of the on-period of one of the upper switching element 32 and the lower switching element 34 is equal to the center point of the off-period of the upper switching element 32 and the lower switching element 34. Therefore, the duty-ratio of the output of the inverter portion 20 is fixed. A controllability of the polyphase motor 12 and a stability of the drive of the polyphase motor 12 can be improved.

The present disclosure is not limited to the embodiments mentioned above, and can be applied to various embodiments within the spirit and scope of the present disclosure.

The upper switching element 32 and the lower switching element 34 are not limited to the n-type MOSFETs. For example, the upper switching element 32 and the lower switching element 34 may be p-type MOSFETs. Alternatively, the upper switching element 32 and the lower switching element 34 can be insulated-gate bipolar transistors (IGBTs).

The polyphase motor 12 is not limited to the DC brushless motor provided with three phases. For example, the polyphase motor 12 may be any motor provided with a plurality of phases (two or more phases).

According to the embodiment, the position detection portion 40 is provided as a member different from the microcomputer 42. However, the position detection portion 40 may be provided in the microcomputer 42. In this case, the position detection portion 40 may function by using hardware, software, or a combination of hardware and software.

According to the embodiment, the microcomputer 42 is used as a PWM controller which generates and outputs control signals having the PWM waveforms. Therefore, the microcomputer 42 includes the target-speed calculation portion 50, the actual-speed calculation portion 52, the difference calculation portion 54, the duty-ratio calculation portion 56, and the PWM-output portion 58. However, at least a part of the above portions may be configured by using hardware. For example, all of the above portions can be configured by using a specific integrated circuit (specific IC) such as an application specific integrated circuit (ASIC), rather than the microcomputer.

According to the embodiment, the inverter control portion 22 includes the drive circuit 44. However, the inverter control portion 22 may not include the drive circuit 44, that is, the drive circuit 44 can be provided as a member different from the inverter control portion 22.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A motor controller controlling a drive of a polyphase motor, the motor controller comprising:
an inverter portion including an upper switching element and a lower switching element which are connected between a power source and the ground in series and corresponds to each phase of the polyphase motor, the upper switching element corresponding to a positive electrode of the upper switching element and the lower switching element; and
an inverter control portion generating control signals having pulse-width modulation waveforms, the inverter control portion controlling a drive of the upper switching element and the lower switching element, wherein
the inverter control portion generates the control signals in such a manner that
(i) different phases of the upper switching element and the lower switching element are synchronously energized and intermittently turned on,
(ii) a pulse-width modulation period of the upper switching element is equal to a pulse-width modulation period of the lower switching element,
(iii) an on-period of one of the upper switching element and the lower switching element is greater than an off-period of the other one of the upper switching element and the lower switching element, and
(iv) the off-period is in a time period from a time point the on-period starts to a time point the on-period completes.

2. The motor controller according to claim 1, wherein
the inverter control portion generates the control signals such that duty-ratios of the different phases of the upper switching element and the lower switching element are set to the same value greater than 50%.

3. The motor controller according to claim 2, wherein
the inverter control portion generates the control signals such that a center point of the on-period is equal to a center point of the off-period.

4. The motor controller according to claim 1, wherein
the polyphase motor is a brushless motor provided with three phases and driven by a signal having a square waveform.
